(19) United States
(12) Patent Application Publication
(10) Pub. No.: US 2002/0011530 A1
(43) Pub. Date: Jan. 31, 2002

(54) MEDIA DISPENSER

(76) Inventor: KARL-HEINZ FUCHS, RADOLFZELL (DE)

Correspondence Address: BAKER & BOTTS, 30 ROCKEFELLER PLAZA, NEW YORK, NY, 10112

(21) Appl. No.: 09/215,754

(22) Filed: Dec. 18, 1998

(30) Foreign Application Priority Data
Dec. 18, 1997 (DE) 197 56 442.9

(51) Int. Cl. B05B 9/043

(52) U.S. Cl. 239/333; 239/337; 239/487; 239/493; 239/373

(57) ABSTRACT

Radial actuation of a handle (15) axially retracts the dispensers shaft (6) inclusive an exit head (9) relative to a base body (5) and a reservoir (7). The shaft (6) is prevented from rotating. The medium thus flows from a pressure chamber (26) via an outlet valve (32) through the entire shaft (6) to a medium exit (20) while being swirled. For facilitated handling the base body (5) and the reservoir (7) form a rod-shaped grip with the handle (15) on one side and a finger scallop (72) on the other.

### TECHNICAL FIELD AND BACKGROUND OF THE INVENTION

The invention relates to a dispenser for media. They can be liquid, powdery, gaseous and/or pasty. The dispenser may be carried and simultaneously operated single-handed. The discharger or deliverer can be a pump, the valve of a pressure vessel, such as an aerosol vessel or the like. The medium may be atomized at the medium exit or a non-atomized jet or droplets or an extruded line.

A small dispenser having an axial actuation stroke of less than 5 mm or 3 mm and a maximum outer diameter of less than 25 mm, 20 mm or 18 mm comprises a handle which could be manually actuated parallel to the axis of the dispenser or transverse thereto. This motion of the handle is to be translated into an axial motion of an actuating shaft. The individual components of such a dispenser are very small. They are sensitive to mechanical loads as well as being difficult to support. An external surface which is irregular over the length of the dispenser and multiply stepped at the outer circumference or in the manual gripping zone may make handling and stowing away difficult.

### OBJECTS OF THE INVENTION

An object is to provide a dispenser which obviates the disadvantages of prior art constructions or of the kind as described. Particularly, the intention is for the dispenser to ensure despite miniature dimensions high mechanical stability, safe and precise functioning as well as being easy to use and uncomplicated to handle.

### SUMMARY OF THE INVENTION

According to the invention means are provided to reliably guide the acuating shaft radially and/or prevented from rotation over a length which is more than half its diameter. This guidance may be provided in the vicinity of the coupling connection between the handle and the shaft and/or directly adjacent upstream thereof. Guidance is done directly on the inner circumference of the outermost shell wall of the base body. The guide part of the shaft may form an axial stop for the actuated end position or for the position remote from the initial position. This stop abuts against an end face of the housing of the deliverer into which the shaft permanently protrudes.

Over its major length or over more than two-thirds or three-quarters of its length, the dispenser in use has constant outer width. This is reduced only in the vicinity of the exit head. Beyond this width bound only the handle protrudes radially outwards. The dispensers overall length is at least five, seven or eight times more than the outer width. Within the length of constant outer width a medium reservoir is longer than the base body by at least half the bodies length. This constantly wide outer circumference extends over a length of at least 8 cm or 10 cm. Thus this outer circumference forms a favorable gripping face while actuating because all fingers of the user hand can surround and support on it. A removable cover for the exit head directly adjoins the base body and the handle by the cited outer width.

The cited, constantly wide circumferential face of the pin-shaped dispenser is interrupted only in sections which extend over part of the length and of the circumference of the base body. These sections in which the circumferential face is transversely offset relative to the constantly wide portions may be a window opening for engaging the handle, an inclined surface for receiving the handle in the actuated end position or a recessed finger scallop remote from the handle.

The cover cap for the exit head engages the inner circumference of the base body. The cap comprises an inclined face which is tensioned relative to a conical end face of the base body or of the handle. Thus actuation is locked in the initial position. In this position the handle protrudes radially beyond the outer circumference of the base body by maximally a third or half of the constant outer width. In every position the handle is spaced from and located between both ends of the base body so that it cannot cover the reservoir.

The exit head comprises a one-part, oblong head cap. The end wall thereof is traversed by a nozzle duct or the medium exit. A separate nozzle core extends from the inside of this end wall exclusively upstream. This core forms an assembly unit with the actuator. The core is located without contact within the head cap over its major length. An outlet duct traverses the actuator shaft and the core body. In cross-section this duct is non-circular but flat. The cross-sectional length of this duct is at least half or twice as large as its cross-sectional width or at least as large or larger than the outer width of the nozzle core. Thus the duct traverses an outer end wall in the region of the ducts narrow sides. The core body emanates from this wall only upstream. The duct forms passage openings at the outer circumference of the core body and adjoining this end face. Through these openings the medium can exit from the interior of the duct to the outer circumference of the core body.

The passage openings extend up to the inner side of an end wall by the outer side of which the core body is located directly adjacent to the end wall of the head cap or to the inner end of the nozzle duct. An axial duct leads from each opening of the core body to the outside of the end wall of the core body from where a transverse duct is directed to the nozzle duct. Each of the cited duct sections is circumferentially sealingly closed. All duct sections connecting downstream to the duct passages traversing the end wall and these passages are bounded in two parts, namely by the actuator shaft and the head cap. Upstream thereof and up to the pressure space of the discharger the duct is located totally within the actuator shaft, which circumferentially entirely bounds the duct in one part. Thus minute dose quantities can be discharged very accurately and thereby atomized.

Reference is made to DE-OS 196 10 456 as regards further features and effects to be incorporated in the present invention.

### BRIEF DESCRIPTION OF THE DRAWINGS

Example embodiments of the invention are explained in more detail in the following and illustrated in the drawings in which:

FIG. 1 is an inventive dispenser in side view and partial cross-section;

FIG. 2 is an exploded side view of the dispenser from the right in FIG. 1, and

FIG. 3 is an enlarged axial view of the nozzle core body.

### DETAILED DESCRIPTION

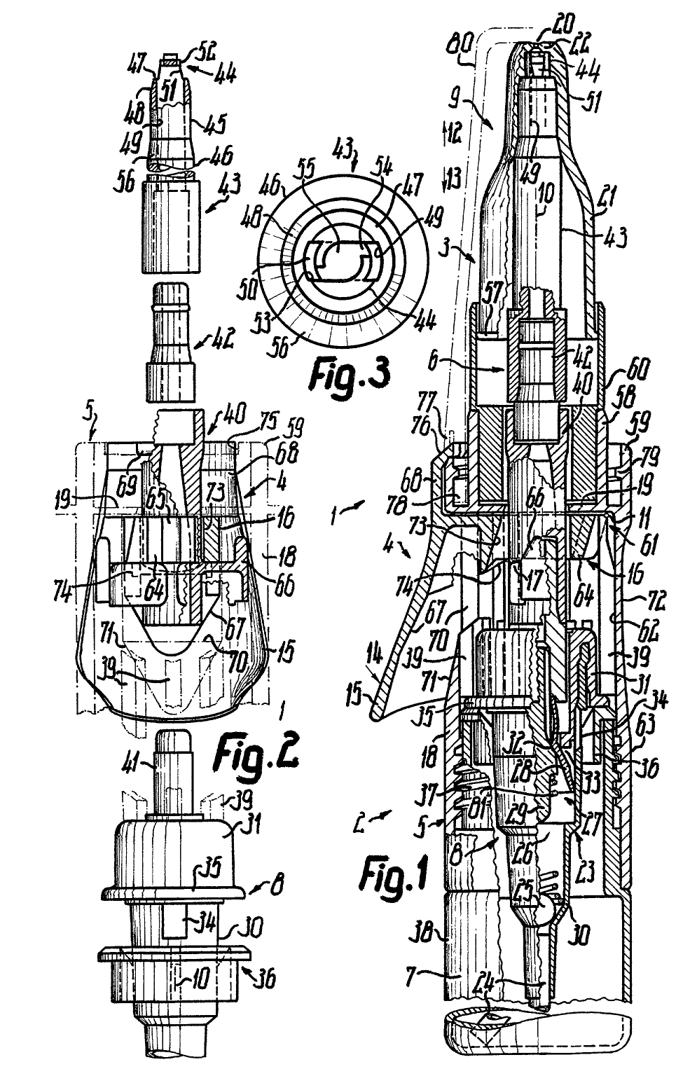

The dispenser 1 comprises two units 2, 3. They are moved axially relative to each other for discharge actuation and for effecting the discharging pressure of the medium. Thereby a third unit 4 is moved transverse to units 2, 3 along a circular arc. Unit 2 comprises a sleeve-shaped base body 5. The base body of unit 3 is an actuating shaft 6. A reservoir 7 and the housing of a discharger, such as a thrust piston pump 8, belongs to the dimensionally rigid unit 2. An exit head 9 located at the end of body 5 facing away from reservoir 7 belongs to unit 3. When made as a single-use discharger without return stroke the reservoir may be formed by the pump housing and totally emptied by a stroke oriented in but a sole direction. All parts of units 2, 3 are located in a common axis 10, relative to which unit 4 is arranged partly eccentric. The medium flows through the dispenser 1 substantially parallel to axis 10 in direction 12 to the free end of head 9 or downstream. Head 9 is retracted in the opposite direction 13 when actuated relative to units 2, 5. Unit 4 forms a handle 15 shown in the initial position in FIGS. 1 and 2. For actuation the handle 15 is pivoted about an axis 11 and caused to approach body 5 at an acute angle to the rear in direction 14. Axis 11 is located within body 5 at right angles transverse to axis 10 on the side thereof which faces away from handle 15.

Unit 4 comprises a driver 16 freely protruding from the inside of dish-shaped handle 15, inserted radially in body 5 and made in one part with units 4, 15. A counter member 17 for driver 16 is provided on actuator 6. Thus the pivot motion of driver 16 results in motion of unit 3 in direction 13. One-part body 5 comprises a jacket or wall 18. Within shell 18 body 5 includes an end wall 19 which is spaced from and located between the ends of shell 18. Wall 19 is located nearer to the downstream end than to the upstream end of body 5. Thus body 5 forms a cap in which a part of reservoir 7, pump 8 and members 16, 17 are located. Driver 16 is located directly adjacent to the inner side of wall 19. The linear member 17 connects upstream to driver 16. Pump 8 and reservoir 7 connect downstream to members 16, 17. Pump 8 extends by its major casing length into reservoir 7.

The free end face of head 9 is traversed by a medium exit 20, namely a nozzle orifice having a diameter of less than half a millimeter. Exit 20 is formed by the outer end of a straight nozzle duct which is widened as a funnel in direction 13. This duct traverses end wall 22 which connects to a shell wall 21 in one part and only in direction 13. The medium leaves exit 20 as an atomized conical jet. Head 9 is tapered in direction 12. Head 9 is suitable for being introduced into a body opening like a humans nostril. Then the slimmer end section which has a diameter of less than 7 mm, protrudes into the nostril and the connecting wider section closes off the nostril. During actuation exit 20 is retracted in the nostril and relative to unit 2. Thus the nostril closure by the wider section of shell 21 is opened and the medium distributed over a major length of the nasal duct.

Pump 8 comprises a two-part casing 23. A riser tube 24 extends from the upstream end of casing 23 to the bottom of reservoir 7. An inlet valve 25 connects downstream to riser tube 24. Ball valve 25 closes and opens tube 24 with respect to a pressure space 26 pressure-dependently. Opposite to valve 25 the space 26 is bounded by a piston unit 27 or the piston 28 thereof. Unit 27 comprises in addition to the sleeve-shaped plunger 28 a piston core 29 which entirely traverses plunger 28. Casing 23 consists of a longer casing jacket 30 and a shorter cap-shaped closure 31 which is fixedly connected to the downstream end of jacket 30 by a snap connector. Piston 28 slides on the inner circumference of shell 30. On this circumference the movable valve element of valve 25 comes into contact. At its downstream end piston 28 comprises an elastically compressible piston neck. Piston 28 and core 29 commonly provide a self-closing outlet valve 32.

Valve 32 opens at a predetermined pressure in chamber 26 or by piston 28 abutting on an inner shoulder of shell 30 at the end of the actuating stroke. A sleeve part of the cover 31, which protrudes into shell 30 in direction 13, forms with piston 28 a valve 33 for venting reservoir 7. The inner circumference of piston 28 forms the movable closing face of valve 32. The outer circumference of piston 28 forms the movable closing face of valve 33. In its initial position valve 33 is sealingly closed while opening with the start of the piston stroke. Shell 30 is traversed by three apertures 34 which are equally distributed about the circumference and connect to cover 31. Space 26 is permanently sealed off relative to apertures 34. Apertures 34 are located in the same axial section as valves 32, 33. Ram 6 traverses cover 31 so that air is able to flow along its outer circumference from outside of the dispenser 1 up to valve 33. With valve 33 opened air then flows through ports 34 as well as along the outside of shell 30 into reservoir 7. When an overpressure exists in reservoir 7 this air is also able to flow out in the counter direction.

On the one-part cover 31 casing 23 comprises an outwardly protruding annular flange 35. Pump 8 is supported and tensioned against an end face of a neck 37 of flask 7 with an interposed member 36. Neck 37 adjoins the flask belly 38 via an annular shoulder against which the upstream end of shell 18 may be tensioned. At this end body 5 comprises a female thread which mates with the male thread of neck 37 and tensions pump 8. Annular member 36 comprises between flange 35 and neck 37 an annular flange and a shell which protrudes exclusively in direction 13 from this annular flange. The shell radially spacedly surrounds apertures 34 or shell 30. For centering shell 30 the member 36 comprises ribs which protrude beyond its inner circumference.

On its inner circumference shell 18 includes at least six, eight or ten axial longitudinal ribs 39 which are circumferentially uniformly distributed. Ribs 39 correspondingly center cover 31 downstream of flange 35. The upstream ends of ribs 39 are axially tensioned against flange 35. Over its full length the outer diameter of belly 38 is the same as the outer diameter of shell 18. Belly 38 may consist of a transparent material or comprise a window to permanently enable visual control of the medium level from outside. As evident from FIG. 2 the largest width of unit 4 and of handle 15 is maximally as large as the diameter of shell 18. The widest portion of handle 15 extends over an angle of more than 100° and less than 180°about axis 10, particularly an angle of 125°. Reservoir 7 may be removed without destruction from body 5 and replenished with medium.

Shaft 6 is assembled of a plurality of five shaft parts which chain longitudinally and are interconnected by axial plug connections. These shaft parts may also be commonly made in one part. For example, a one-part shaft 41 to 44 and/or 40, 42, 43 is expedient. Core 29 forms the upstream end of shaft 6. To the stem of core 29, which protrudes downstream over piston 28, a shaft part 41 connects, which has the same length as core 29 and in the interior of which the core shaft is plugged in. The reduced downstream stem section of portion 41 is plugged into the interior of longer shaft part 40. The downstream end of part 40 overlaps the outside of the shortest shaft part 42. Part 42 engages the interior of the next, longest shaft part 43. Thus the mutually facing ends of both shaft parts 40, 43 are directly juxtaposed. When in one part the outer width of shaft 6 is continuously reduced in direction 12 and not increased. The downstream end of part 43 forms a core body 44 for nozzle cap 21, 22. The end face of body 44 contacts the inside of end wall 22, possibly axially tensioned.

The length of core 44 is at the most as large as its diameter which may conically taper by a few degrees in direction 12 or 13. In direction 13 the core 44 connects to a widened shaft section 45. In direction 13 a further widened section 46 connects to section 45. An again widened socket (not shown in FIG. 3) connects to section 46 and receives part 42. The transition between sections 44, 45 is formed by flat annular shoulder 47 to which section 45 connects via a cone 48 constricted at an acute angle in direction 12. All cited sections of part 43 are commonly in one part. Part 43 is traversed by a duct 49 which in FIG. 3 is rectangular and flat. The narrow sides of duct 49 are concavely curved about axis 10. The cross-sectional length of duct 49 is at least twice as large as its cross-sectional width or half thereof. Furthermore, the cross-sectional length is at least as large as the outer diameter of core 44. Thus duct 49 emerges at the end face 47 only in the vicinity of its narrow sides. In face 47 the duct 49 forms graduated annular ports 50. Ports 50 are curved about axis 10 and oppose each other on both sides of axis 10. Duct 49 also emerges over the same or smaller width at the outer circumference of core 44 with ports 51 which face away from each other. Thus in each case two ports 50, 51 are interconnected at an angle. Duct 49 and ports 51 extend up to an inside of an end wall 52 of core 44. This inside is remote from end face 47. The thickness of wall 52 is smaller than the outer diameter of core 44 or half thereof. The outer diameter of core 44 is smaller than 4 mm or 3 mm.

As viewed in FIG. 1 the port 51 may be constricted in width at an acute angle in direction 13. If in production of part 43 the duct 49 is injection molded with a mold core or mandrel the shape of port 51 is achieved alone from the conicity of core 44. The mold core simultaneously forms ports 50, 51 and the inside of wall 52. Wall 52 is connected to section 45, 48 only via two mutually opposing legs separated by ports 51. These legs bulge radially outwards when axially tensioned and can thereby be sealingly pressed against the inner circumference of shell 21. Each of sections 45, 48, 56 is circumferentially and over its entire length in sealing and full contact with the inner circumference of shell 21. Section 46 is at least twice as long as each of sections 45, 48, 56. Section 46 is entirely without contact inside of shell 21. Parts 29, 41, 40, 42, 43 are connected to each other resistant to tensile stress, for example, by bonding, welding or snap connectors. Except for core 29 all of these shaft parts are internally traversed by continuations of duct 49 or by central longitudinal bores.

To the downstream end of port 51 a longitudinal groove 53 of same width connects. This shallow depression 53 in the outer circumference of core 44 is sealingly covered at its open side by the inner circumference of shell 21. Thus groove 53 and port 40 commonly form a shallow duct having the same cross-sections as port 50. This shallow duct is traversed by port 51 at its associated flat side and at its upstream end. Port 51 extends up to wall 52. The named flat side is traversed by a transverse duct 54 downstream of port 51. Duct 54 is formed by a groove in the outside of wall 52. The open groove side of this groove is sealingly covered by the inside of wall 22. Duct 54 has significantly smaller flow cross-sections than ports 50, 51 and duct 53. Port 54 issues into a widened chamber 55 towards axis 10. Chamber 55 is formed by a circular depression in the outside of wall 52. Chamber 55 has the same diameter as the inner end of the nozzle duct. This end is widened and directly connects to chamber 55 which is coaxial with the nozzle duct. Ducts 54 issue tangentially into chamber 55 in opposing directions and laterally offset from each other. Thus medium flow is caused to swirl and to rotatingly pass the nozzle duct.

At the upstream end the shell 21 comprises one or more cams or annular beads 57 which protrude beyond its outer circumference. Cam 57 centers and sealingly guides head 9 at an inner circumference of unit 2. Body 5 comprises two nested shell walls 58, 59 at its downstream end. Shells 58, 59 are mutually radially spaced and protrude from wall 19 in direction 12. Inner jacket 58 protrudes further than outer jacket 59. The outer circumference of shell 59 forms a smooth continuation of the constant outer circumference of shell 18. A sleeve-shaped member 60 is inserted in shell 58. Member 60 may also be in one part with body 5. Part 60 axially abuts shell 58 in direction 13. Part 60 protrudes beyond shell 58 in direction 12 by a sleeve section. Member 57 sealingly slides on the inner circumference of this sleeve section. The shaft parts 40, 43 may be supported against radial motions within shell 58 or on the inner circumference of part 60. Part 60 is secured to shell 58 by a press fit. Shell 21 is permanently spaced from unit 4 or handle 15 in direction 12.

Axis 11 is defined by a bearing 61 or a knife-edge suspension. The knife edge is formed by an acutely angled corner zone of driver 16. The rectangularly flanked bearing reception is formed by the inside of wall 19 and the length edge of a rib connecting to wall 19. The spacing between axes 10, 11 is slightly less than the radius of the curved inner circumference 62 of shell 18 from which ribs 39 emanate. The rib height of the bearing cup is smaller than the height of ribs 39. The ribs of the bearing reception are significantly shorter than ribs 39 and directly connect to both sides of one of ribs 39. Ribs 39 permanently engage inside a groove 65 of driver 16. For this purpose driver 16 comprises a projection 64 at its end which is remote from handle 15. The width of projection 64 is reduced relative to driver 16 (FIG. 2). Projection 64 includes groove 65. The widened section of driver 16 comprises a passage for shaft 6 or part 40. This passage is located between projection 64 and handle 15. Parts 6, 4 are inserted into body 5 and unit 4 in direction 12, like units 7, 8 are.

Sleeve-shaped part 40 is in one part with counter members 17. Members 17 protrude beyond the outer circumference of sleeve 40 at two remote sides and form a crossbeam. In view of FIG. 1 members 17 do not protrude beyond the outer circumference of sleeve 40. Members 17 are located nearer to the upstream end than to the downstream end of sleeve 40. At its ends the crossbeam comprises cams 66 which protrude in direction 12 and which are narrower than the crossbeam. Each cam 66 is guided and prevented from rotation between two juxtaposed ribs 39. Each cam 66 spacedly and laterally overlaps driver 16.

Member 17 forms a straight edge or slide face between cam 66 and the opposite outer circumference of sleeve 40. The web-shaped drive cam 74 of driver 16 permanently supports against this edge with pressure and between axis 10 and handle 15 within shell 18. Motion of handle 15 in direction 14 thus results immediately in motion of unit 3 in direction 13. Components 6, 9, 27 belong to unit 3. Unit 4 is in one part. In the initial position part 40 extends from cover 31 through driver 16 up into shell 58. Thus part 40 protrudes beyond unit 4 in direction 12. Counter faces 17 are formed by two edges of the crossbeam. These edges are rounded and mutually aligned. Faces 17 are located radially within cam 66 and on both sides of sleeve 40.

Handle 15 is curved about axis 10 to form a tray. The width of handle 15 increases in direction 13 over its major length and then decreases again. Thus side wings are formed between the handles ends. The wings are less thick than 1 mm. While laying the wings against the outer circumference 63 of shell 18 these wings are resiliently spreaded. Thus the width of handle 15 increases. The wing thickness increases towards the middle of the width of handle 15. Thus the handle 15 is dimensionally stiff in its median zone including the driver 16 emanating therefrom. This median zone includes a wall thickening 67 which adjoins the driver 16 upstream and reinforces both members 15, 16. Also a projection 68 of unit 4 may be tray-shaped and resiliently widenable. Jut 68 protrudes beyond driver 16 in direction 12. Jut 68 permanently tightly envelopes the outer circumference 63 over an arc angle which is smaller than that of the wings or maximally 100°.

Jut 68 includes on its inside and downstream end a protruding cam 69. Cam 69 is in contact with the end face of shell 59 in the initial position. Shell 59 and cam 69 have the same radial spacing from shell 58. In this zone a depression 75 is provided in the end face 59 (FIG. 2). The inclined end section of jut 68 including cam 69 engages inside depression 75. In the initial position unit 4 is positionally locked by cam 69 providing a snap connector. This non-positive or frictional locking can only be overcome with a snap effect or audible click by applying a corresponding high actuating force. Shell 18 is traversed by a rectangular window 70 extending only up to the inside of wall 19. Driver 16 is inserted into window 70 radially and transverse to axis 10. From the upstream transverse bound of window 70 and at the outer circumference 63 extends a planar surface 71 which is inclined away from axis 10 in direction 13. The complementary inclined surface of reinforcement 67 may be brought fully into contact with face 71 when handle 15 is in the actuated end position.

Handle 15 covers aperture 70 permanently completely. For this window 70 and driver 16 have the same width but are significantly narrower than handle 15. Window 70 extends about axis 10 over an arc angle of less than 90°. Circumference 63 is provided with a depression 72 on its side facing away from handle 15. Depression 72 extends over an arc angle of more than 100° and less than 120°. The depression depth increases more inclined at the depressions downstream end than at the upstream end. The users thumb or index finger finds support in this scallop when handle 15 is actuated, according as whether handle 15 is actuated by the thumb or index finger. The inner circumference 62 is also constant in width in the vicinity of scallop 72. Thus in this zone shell 18 is significantly less thick than 1 mm.

As seen in FIGS. 1 and 2 the driver 16 has the shape of a flat plate. In FIG. 1 this plates thickness increases only between axis 10 and handle 15. Actuator 6, 40 traverses passage 73 of driver 16. Passage 73 is an oblong hole which is circumferentially entirely bounded. The minor width of hole 73 is located in the cross-sectional plane of FIG. 2. This width is closely adapted to the corresponding diameter of section 40 with clearance near to zero. The cross-sectional length of hole 73 is located in the cross-sectional plane of FIG. 1 oriented perpendicular to the plane of FIG. 2. In the initial position the hole end remote from handle 15 is parallel to axis 10 and the end facing handle 15 is acutely inclined away from axis 10 in direction 13. In the vicinity of this latter end the inclined cams 74 located on both sides of hole 73 slide on counter cams 17. Jut 68 form a tray which is curved about axis 10 and includes an end face 76. Face 76 is inclined to be conically flared in direction 13. Face 76 is located on the radial outside of cam 69. When cam 69 engages cutout 75 then face 76 forms a smooth continuation of the analogous end or inclined surface of shell 59.

A counter member 77 may be axially tensioned in direction 13 against face 76. Member 77 thereby radially resiliently yields slightly. Member 77 is annularly continous about axis 10 and therefore tensioned against the end face of shell 59 in the same way. Thus member 77 sealingly closes this end of shell 18 and unit 4. A sleeve-shaped member 78 protrudes beyond the tensioning end face of member 77 and out of the interior thereof in direction 13. Member 78 has a twin-pitch male thread for mating with the female thread 79 of shell 59. A rotation of maximum 180° or 90° is sufficient for screwing member 78 on or off. The inner circumference of sleeve 78 may sealingly contact the outer circumference of shell 58, 60. Members 77, 78 may be in one part with a cap-shaped cover 80 fully receiving head 9 and shells 58, 60 while sealingly directly closing exit 20. Cover 80 locks unit 4 against actuation without motion play and tensiones unit 4 radially toward axis 10.

Following removal of cover 80 the handle 15 is actuated by finger pressure in direction 14, the cam 69 thereby unsnapping. Thus actuator 6 instantly moves in direction 13, plunger 28 pressurizes the medium which fills chamber 26 entirely. Thereby valve 25 is tensioned in its closed position. After an axial stroke of between 2 mm and 3 mm valve 32 opens. Then the medium flows between piston 28 and core 29 in direction 12 into the shaft sections. The medium emerges axially as well as radially from the actuator 6 not before reaching openings 15, 51. Then the medium is caused to rotate in chamber 55 whereafter it is atomized at the bound edge of exit 20. In addition to the force of a return spring 81 a steeper increase of the actuating force is effected over the last stroke section, since the wings of handle 15 must be spreaded on circumference 63. Spring 81 is located within chamber 26 and is permanently supported with axial pretension on core 29. Valve 32 recloses automatically at the stroke end. Following its release handle 15 and cams 74 are first lifted off from member 17 by the resilient return action of its wings. Simultaneously spring 81 returns unit 3 and also unit 4 to their initial position which is stop limited. Thereby valve 25 opens due to evacuation of chamber 26. Thus while valve 32 is closed medium is sucked from reservoir 7 into chamber 26 via duct 24.

For assembly pump 8 including ring 36 may be inserted in direction 12 into body 5 up to abutment. Thereby the entire actuator 6 can be inserted in the same direction through the passages provided in driver 16, wall 19, sleeve 60 and head 9. The dimensions or the dimensional relationship shown are particularly favorable for use of the dispenser 1. All components may consist of plastic material or produced as injection molded items. All properties and effects may be provided precisely as described, or merely roughly so or substantially so, but may also deviate therefrom even more so for corresponding applications. Except for the wings of handle 15, plunger 28 and spring 81 each of the components or sections thereof as cited is dimensionally rigid in operation.

1. A dispenser for discharging medium comprising:
a base body (5) including an end wall (19) and defining a central axis (10);
a reservoir (7) for storing the medium;
a discharger (8) for forcing the medium through said end wall (19), said discharger (8) being mounted on said base body (5);
a handle (15) for actuating said discharger (8) and including a driver (16);
an exit head (9) including a medium exit (20), and
an actuating shaft (6) connecting said discharger (8) with said exit head (9) and engageable with said driver (16), said actuating shaft (6) being movable relative to said base body (5), said actuating shaft being centered and displaceably guided between said end wall (19) and said discharger (8) relative at least one of
said base body (5), and
said handle (15).

2. The dispenser according to claim 1, wherein said actuating shaft (6) is rotationally limited with respect to at least one of
said handle (15), and
said base body (5).

3. The dispenser according to claim 1, wherein said actuating shaft (6) is directly guided on said base body (5).

4. The dispenser according to claim 1 and further including a slide cam (66) and a groove (39) displaceably receiving said slide cam (66), wherein said slide cam (66) and said groove (39) movably guide said actuating shaft (6).

5. The dispenser according to claim 1 and further including a port (70) on said base body (5) which includes an outer circumference (63), wherein said handle (15) is located at said outer circumference (63), said driver (16) projecting through said port (70) into said base body (5).

6. The dispenser according to claim 5, wherein said driver (16) directly engages said base body (5) at a location opposing said port (70), said location (61) including means for positively preventing rotation of said driver (16).

7. The dispenser according to claim 1 and further including a pivot axis (11) for pivotably displacing said driver (16) wherein said base body (5) includes an inner circumference (62) including a concave inside face, said pivot axis being radially inwardly displaced with respect to said concave inside face (62).

8. The dispenser according to claim 5, wherein said port (70) includes a port bound (71) which is tapered in cross-section to include a wedge shape.

9. The dispenser according to claim 5, wherein said outer circumference includes remote ends which are mutually axially spaced, said outer circumference (63) including an inclined face (71) located between said remote ends and spaced from both said remote ends.

10. The dispenser according to claim 9, wherein said handle (15) is a tray including a tray inside, said tray inside including a counterface (67) located directly adjacent to said inclined face (71) when said handle (15) is manually actuated.

11. The dispenser according to claim 1, wherein said handle (15) includes a tray including tray legs, said tray legs being operationally resiliently deformable.

12. The dispenser according to claim 1, wherein said driver (16) includes a transition port (73) circumferentially entirely bounded by a transition bound, said transition bound projecting towards said discharger (8) and being circumferentially varyingly spaced from said discharger (8).

13. The dispenser according to claim 1, wherein said driver (16) is externally overlapped by said actuating shaft (6).

14. The dispenser according to claim 12 and further including a pivot axis (11) for pivotably actuating said driver (16), wherein said driver (16) includes a driver face (74) for axially pushing said actuating shaft (6), said transition bound including a bound zone most far away from said pivot axis (11), said driver face being less spaced from said pivot axis than said bound zone.

15. The dispenser according to claim 1, wherein downstream of said end wall (19) said base body (5) includes jacket walls (58, 59) including an outer wall (59) and an inner wall (58), said inner wall (58) being located inside said outer wall (59), said actuating shaft (6) traversing said jacket walls (58, 59).

16. The dispenser according to claim 15, wherein said outer wall (59) defines an outside, said handle (15) being located at said outside.

17. The dispenser according to claim 1, wherein said base body (5) includes a downstream end radially overlapped by said handle (15).

18. The dispenser according to claim 5, wherein said handle (15) covers said base body (5) downstream directly adjacent to said port (70).

19. The dispenser according to claim 15, wherein said inner wall (58) axially projects over said outer wall (59) and supports said exit head (9).

20. The dispenser according to claim 1 and further including a nozzle duct and a nozzle core (44), wherein said nozzle duct is linear and bounded in one part, said nozzle duct including a downstream end including said medium exit (20), said nozzle duct including an upstream end enveloped by a shoulder, said nozzle core (44) including a core face directly opposing said shoulder, exclusively upstream of said core face said nozzle core (44) being internally traversed by a core duct (49) which is flat in cross-section, said nozzle core including an outer circumference and a core shoulder projecting radially outwardly at said outer circumference, a longitudinal groove (53) connecting to said outer circumference, said core duct (49) emerging at said outer circumference and at said core shoulder (47) into said longitudinal groove (53).

21. The dispenser according to claim 20, wherein said logitudinal groove (53) and said core body (44) include a groove bottom, said core face including a transverse groove (54) directly connecting said groove bottom radially inwardly with said upstream end.

22. The dispenser according to claim 1 and further including a nozzle duct and a nozzle core (44), wherein said nozzle duct is linear and bounded in one part, said nozzle duct (44) including an upstream end covered by said nozzle core (44), said actuating shaft (6) including said nozzle core (44).

23. The dispenser according to claim 1 and further including a nozzle duct and a head casing (21, 22) traversed by said nozzle duct, wherein said actuating shaft (6) includes a major length section freely exposed without contact inside said head casing (21, 22).

24. The dispenser according to claim 1 and further including a circumferential side remote from said handle (15), wherein said base body (5) includes circumferential sections and an actuating face (72) bilaterally circumferentially directly connecting to said actuating face (72), said actuating face (72) being radially displaced with respect to said circumferential sections providing external circumferential faces, said actuating face (72) being located at said circumferential side.

25. The dispenser according to claim 1 and further difining a length extension, over which said reservoir (7) engages inside said base body (5), wherein said base body (5) includes an external circumferential face (63) freely exposed and defining a width extension, said width extension being substantially constant over said length extension, said base body (5) being shorter than said reservoir (7) and including remote ends, said handle (15) being permanently located between said remote ends.

26. The dispenser according to claim 1 and further including an actuated end position of said handle (15), wherein said base body (5) externally includes a circumferential face (63) freely exposed, in said actuated end position said handle (15) inherently resiliently directly supporting against said circumferential face (63).

27. The dispenser according to claim 1, wherein said base body (5) includes an inner circumference including at least one guide groove, said actuating shaft (6) being guided in said at least one guide groove and being axially stop limited.

28. The dispenser according to claim 1 and further including a cover cap (80) for releasably receiving said exit head (9), wherein said base body (5) includes intermeshed jackets (58, 59), when operationally covering said exit head (9) said cover cap (80) projecting between said intermeshed jackets (58, 59) and radially tensioning said handle (15) against being actuated.
